(19) United States
(12) Patent Application Publication
(10) Pub. No.: US 2004/0166021 A1
(43) Pub. Date: Aug. 26, 2004

(54) Multiplex test kit

(76) Inventor: Hubert Hsu, Taipei (TW)

Correspondence Address: BACON & THOMAS, PLLC, 625 SLATERS LANE, FOURTH FLOOR, ALEXANDRIA, VA, 22314

(21) Appl. No.: 10/368,567

(22) Filed: Feb. 20, 2003

(51) Int. Cl. G01N 31/22

(52) U.S. Cl. 422/61

(57) ABSTRACT

The present invention discloses a multiplex test kit comprising a plurality of sample carrier zones and/or a plurality of reaction zones and sample liquid absorption zone(s). In the sample carrier zones, one or more reagents and/or tracers may be prepared, while in the reaction zones one or more reagents/tracers are prepared. If a plurality of sample carrier zones is provided, different or same reagent and/or tracer may be prepared in different sample carrier zones. If a plurality of reaction zones is provided, different or same reagent/tracer may be prepared in different reaction zones.

### FIELD OF THE INVENTION

The present invention relates to a novel test kit, especially to a test kit to be used in a multiplex reaction.

### BACKGROUND OF THE INVENTION

The test kit, especially test kits for single step reactions, has been widely used in all kinds of biochemical tests. Such test kits are used to decide the existence of particular substance (analyte) in a sample liquid to effectively and rapidly screen a quantity of samples. Samples with an indication of the existence of analyte may be tested in a more sophisticated process for detailed verification.

With the development of biochemical technologies, the conventional single-step test kits, with which single-step combination of a sample with a particular antibody or antigen, has become less useful. For many kinds of test, samples are pre-processed under a multiple step chemical reaction before they can be put to test by a test kit. In other cases, the samples need to combine with a variety of antibodies and/or antigens in a particular sequence, or to react in a plurality of steps, so that correct test results may be obtained. In these tests, it is difficult to use the conventional single-step test kits to conduct the test.

It is thus necessary to provide a novel test kit to be used in biochemical reactions with a plurality of reaction steps.

It is also necessary to provide a novel test kit to be used in biochemical reactions wherein test samples are reacted with a plurality of antibodies and/or antigens.

It is also necessary to provide a novel test kit to be used in biochemical reactions wherein a plurality of samples is reacted with a plurality of antibodies and/or antigens.

### OBJECTIVES OF THE INVENTION

One objective of this invention is to provide a novel test kit to be used in biochemical reactions with a plurality of reaction steps.

Another objective of this invention is to provide a novel test kit to be used in biochemical reactions wherein test samples are reacted with a plurality of antibodies and/or antigens.

Another objective of this invention is to provide a novel test kit to be used in biochemical reactions wherein a plurality of samples is reacted with a plurality of antibodies and/or antigens.

### SUMMARY OF THE INVENTION

The present invention discloses a multiplex test kit comprising a plurality of sample carrier zones and/or a plurality of reaction zones and sample liquid absorption zone(s). In the sample carrier zones, one or more reagents and/or tracers may be prepared, while in the reaction zones one or more reagents/tracers are prepared. If a plurality of sample carrier zones is provided, different or same reagent and/or tracer may be prepared in different sample carrier zones. If a plurality of reaction zones is provided, different or same reagent/tracer may be prepared in different reaction zones.

The above and other objectives and advantages of this invention may be clearly understood from the detailed description by referring to the following drawings.

### BRIEF DESCRIPTION OF THE DRAWINGS

FIG. 1 illustrates the stereoscopic view of the first embodiment of the invented multiplex test kit.

FIG. 2 illustrates the stereoscopic view of the second embodiment of the invented multiplex test kit.

FIG. 3 illustrates the stereoscopic view of the third embodiment of the invented multiplex test kit.

FIG. 4 illustrates the stereoscopic view of the fifth embodiment of the invented multiplex test kit.

### DETAILED DESCRIPTION OF THE INVENTION

Embodiments of the multiplex test kit of this invention will be given to illustrate the present invention in the followings.

The multiplex test kit of this invention comprises a plurality of sample carrier zones and/or a plurality of reaction zones and sample liquid absorption zone(s). In the sample carrier zones, one or more reagents and/or tracers may be prepared, while in tile reaction zones one or more reagents/tracers are prepared. If a plurality of sample carrier zones is provided, different or same reagent and/or tracer may be prepared in different sample carrier zones. If a plurality of reaction zones is provided, different or same reagent/tracer may be prepared in different reaction zones.

Embodiment I

FIG. 1 illustrates the stereoscopic view of the first embodiment of tile invented multiplex test kit. As shown in this figure, the multiplex test kit of this invention includes a substrate 10 and, supported on said substrate 10, a first sample carrier zone 11, a second sample carrier zone 12, a reaction zone 13 and a sample liquid absorption zone 14. In this embodiment, the first sample carrier zone 11 and the second sample carrier zone 12 are connected at their one end to form a connection zone 15. In the connection zone 15, a trip of reagent and/or tracer 15a is prepared at a selected position. On the other hand, in the reaction zone 13, two strips of reagent and/or tracer 13a, 13b are prepared at selected positions.

The substance 10 may be prepared with a firm material. Preferably, the material is resisting to humid, such that the substrate 10 is not damaged when a liquid is applied on it. The shape of the substrate 10 may be a Y-shaped strip or another applicable shape. Materials suited for the substrate 10 in this invention include: plastic, resin, glass, metal, paper coated with a humid-resist layer, or other applicable materials, as long as the material is firm and is easy to use.

The sample carrier zones 11, 12 and the connection zone 15 are prepared with a lamination of fiber materials. Materials applicable for the sample carrier zones 11, 12 and the connection zone 15 are preferably those able to provide capillary attraction or capillary forces to charge a liquid. Suited materials include: fiberglass, cellulose, nylon, crosslinked dextran, various chromatographic papers, nitrocellulose, etc. A particularly preferred material is nitrocellulose. Material of the lamination may be same or different from layer to layer, and so are their porous sizes.

In the connection zones 15, a strip of reagent is prepared. In the reaction zone 13, two strips of reagent and/or tracer that may be charged by the sample liquid are applied. The reagent may be a substance able to react with a test substance contained or not contained in the test sample or a substance able to react with the binder of the reagent or the tracer, applied in the reaction zone 13, or both, depending on the application.

The tracer may be any kind of detectable substance or its composition. Applicable materials include: ferritin, phycoerythins or other phycobili-proteins, precipitated or insoluble metals or alloys, fungal, algal, or bacterial pigments or derivatives such as bacterial chlorophylls, plant materials or derivative metal sols and the like.

The material of the reaction zone 13 may be any material able to provide capillary attractions or capillary forces necessary in charging the sample liquid. Suited materials include: fiberglass, cellulose, nylon, crosslinked dextran, various chromatographic papers, nitrocellulose, etc. A particularly preferred material is nitrocellulose.

At selected positions of the reaction zone 13, two strips of reagent and/or tracer are applied. Suited reagents include any substance able to react with a test substance contained or not contained in the test sample or a substance able to react with the binder of the reagent and/or tracer, applied in the connection zone 15, or both, depending on the application.

Suited tracers include ferritin, phycoerythrins or other phycobili-proteins, precipitated or insoluble metals or alloys, fungal, algal, or bacterial pigments or derivatives such as bacterial chlorophylls, plant materials or derivative metal sols and the like.

The reaction zone 13 is preferably closely connected to the connection zone 15. In some embodiments of this invention, an edge of the reaction zone 13 overlaps an edge of the connection zone 15.

Material of the liquid absorption zone 14 may be any material able to absorb liquid. The major purpose of the liquid absorption zone 14 is to absorb surplus sample liquid, such that the reaction zone 13 and the reagent and the tracer in the reaction zone 13 won't be soaked in the sample liquid after the reaction and that the movement of the sample liquid may be accelerated. Suited materials of the liquid absorption zone 14 include fiberglass, cellulose, synthetic high molecular and the like. A particularly preferably material is cellulose filter paper.

The liquid absorption zone 14 is preferably connected closely to the reaction zone 13, so to facilitate the absorption of the residual sample liquid.

The multiplex test kit so prepared may be used in the following way. Different liquid test samples are dropped onto the first sample carrier zone 11 and the second sample carrier zone 12, respectively and simultaneously. Due to the capillary forces of the sample carrier zones 11, 12, the sample liquid will proceed to the connection zone 15 and react with the reagent and/or tracer 15a, or react with each other first and then with the reagent and/or tracer 15a. Thereafter, driven by the capillary forces of the connection zone 15 and the reaction zone 13, the sample liquid will proceed to the reaction zone 13 and react with the reagent and/or tracer 13a, 13b, respectively. Results of tile reactions will be displayed at the reaction zone 13. The surplus test liquid is absorbed by the sample liquid absorption zone 14.

Embodiment II

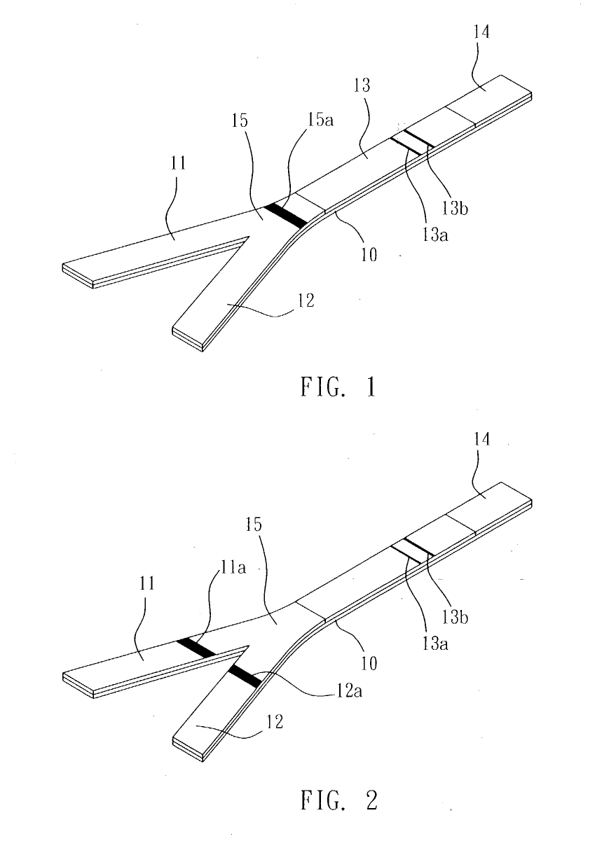

FIG. 2 illustrates the stereoscopic view of the second embodiment of the invented multiplex test kit. In this figure, elements, which are the same with that of FIG. 1, are labeled with same numbers. As shown in FIG. 2, the multiple test kit of this embodiment has the same structure of that of the first embodiment. The major difference between them is that, in this embodiment, two trips of reagent and/or tracer are provided at the first sample carrier zone 11 and the second sample carrier zone 12, respectively. Reagent and/or tracer prepared in the different sample carrier zones 11, 12 may be the same or different. If different reagents or tracers are used, sample to be tested should be one. If otherwise, sample to be tested should be different.

The operation of the second embodiment is similar to that of the first embodiment. Detailed description is thus omitted.

Embodiment III

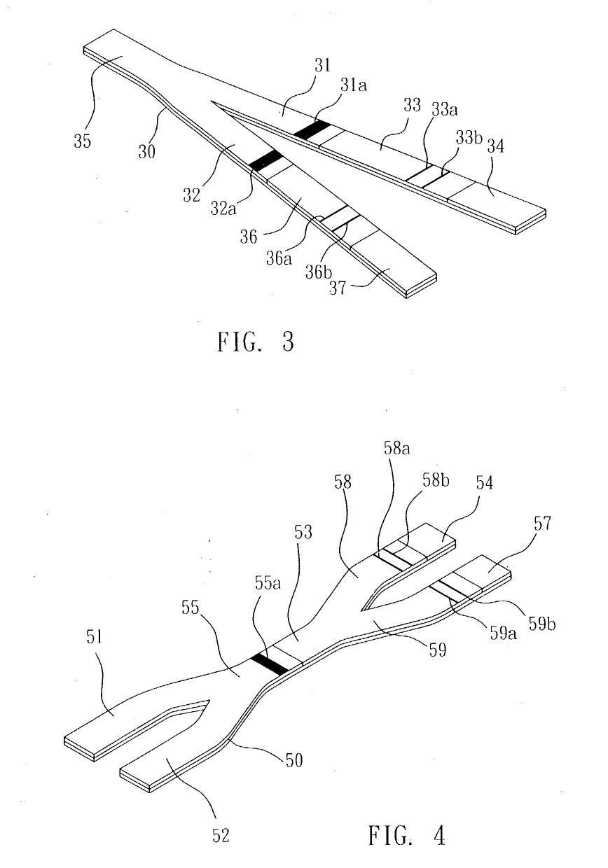

FIG. 3 illustrates the stereoscopic view of tie third embodiment of the invented multiplex test kit. As shown in this figure, the multiplex test lit of this embodiment includes a substrate 30, two sample carrier zones 31 and 32, connected at their upstream end to form a connection zone 35, two reaction zones 33, 36 connected to the two sample carrier zones 31, 32, respectively, and two sample liquid absorption zones 34, 37 connected to said two reaction zones 33, 36, respectively. In this embodiment, the material and the preparation of the connection zone 35, the sample carrier zones 31, 32, the reaction zones 33, 36 and the sample liquid absorption zones 34, 37 are similar to that of the First and second embodiments.

In this embodiment, one strip of reagent and/or tracer 31a, 32a is prepared in each sample carrier zone 31, 32 and two strips of reagent and/or tracer 33a, 33b and 36a, 36b are prepared in each reaction zone 33, 36, respectively. The reagent and/or tracer used in different sample carrier zones 31, 32 is of the same kind, while the reagent and/or tracer used in different reaction zones 33, 36 is of different kind.

In operation, sample is dropped onto the connection zone 35 and proceeds to react with the reagent and/or tracer at the sample carrier zones 31, 32, due to capillary forces. Thereafter, the sample continues to proceed to react with the regent and/or tracer at the reaction zones 33, 36. Results of the reactions are displayed in the reaction zones 33, 36. The surplus sample liquid is absorbed by the sample liquid absorption zone 34, 37. With this mechanism, one sample may react with different reagents and the results are displayed at the same time.

Embodiment IV

The major difference between Embodiment IV and Embodiment III rests in that the reagent and/or tracer prepared in different sample carrier zones 31, 32 is of different kind, while the reagent and/or tracer prepared in different reaction zones 33, 36 is of the same kind. As a result, one sample may react with different reagents and then with the same other reagent.

Embodiment V

FIG. 4 illustrates the stereoscopic view of the fifth embodiment of the invented multiplex test kit. As shown in this figure, the multiplex test kit of this embodiment comprises a substrate 50, two sample carrier zones 51, 52 and their connection zone 55 at their downstream end, reaction zone 53 at a further downstream position and its branch reaction zones 58, 59, and the utmost downstream sample liquid absorption zones 54, 57. A strip of reagent and/or tracer 55a is prepared in the connection zone 55. Two strips of reagent and/or tracer 58a, 58b and 59a, 59b are provided in the branch reaction zones 58 and 59, respectively. The material and preparation of the elements and the reagent, the tracer are similar to that of Embodiment I-IV. In this embodiment, the reagent and/or tracer applied to different branch reaction zones 58 and 59 may be different.

In the operation, different samples are dropped to the sample carrier zones 51, 52, respectively. The samples will proceed to react with each other first and then with the reagent and/or tracer at the connection zone 55 under the capillary force of the sample carrier zones 51, 52 and the connection zone 55. Thereafter, the sample proceeds to react with the reagent and/or tracer at the branch reaction zones 58, 59. Result of the reactions is displayed in the branch reaction zones 58, 59, respectively. The surplus sample liquid is absorbed by the sample liquid absorption zone 54, 57.

In the multiplex test 111t of this embodiment, it is possible to provide different or the same reagent and/or tracer at selected positions of the sample carrier zones 51, 52.

### EFFECTS OF THE INVENTION

With the multiplex test kit of this invention, it is possible to conduct biochemical tests in a variety of combination of sample, reagent and/or tracer. If the reaction between or among samples is ignored, in a multiplex test kit having two sample carrier zones and/or two reaction zones, it is possible to conduct at least the following biochemical reactions:

| Sample | Reagent | Tracer |
|---|---|---|
| Same | Same | Same |
| Different | Same | Same |
| Same | Different | Same |
| Different | Different | Same |
| Same | Same | Different |
| Different | Same | Different |
| Same | Different | Different |
| Different | Different | Different |

If the number of sample carrier zone and/or reaction zone is increased, more combinations are made possible. It is thus useful in biochemical reactions with multiplex steps. The present invention is not limited to the case where only two sample carrier zones or only two reaction zones are provided.

Although in the above description, biochemical reactions are illustrated, this invention is not limited to the application of the biochemical reaction. Other physical, chemical, imunological reactions may also be applicable to this invention. In addition, although in the above description, the multiplex test kit is in the normal size as that of the commercially available test kits, it is understood that the present invention may be realized in a miniature size. For example, the multiplex test kit may be realized in a substrate in chip sizes or used as a test module of a reaction system. These and other variations shall be within the scope of this invention.

As the present invention has been shown and described with reference to preferred embodiments thereof those skilled in relevant arts will recognize that other changes may be made therein without departing from the concept and scope of the invention.

What is claimed is:

1. A multiplex test kit, comprising:
a substrate;
at least two sample carrier zones to charge sample to be tested with capillary forces;
at least one reaction zone positioned at a downstream position to said sample carrier zones and provided with reagent and/or tracer at selection position or positions; said reaction zone being able to charge said sample with capillary forces; and
sample liquid absorption zone position at a downstream position to said reaction zone to absorb liquid contained in said sample;
characterized in that at least one end of said at least two sample carrier zones combine into a connection zone.

2. A multiplex test kit, comprising:
a substrate;
at least one sample carrier zone to charge sample to be tested with capillary forces;
at least two reaction zones positioned at downstream positions to said sample carrier zone and provided with reagent and/or tracer at selection position or positions;
said reaction zone being able to charge said sample with capillary forces; and
sample liquid absorption zone position at downstream positions to said reaction zones to absorb liquid contained in said sample;
characterized in that at least one end of said at least two reaction zones combine into a connection zone.

3. A multiplex test kit, comprising:
a substrate;
at least two sample carrier zones to charge sample to be tested with capillary forces;
at least two reaction zone positioned at downstream positions to said sample carrier zones and provided with reagent and/or tracer at selection position or positions;
said reaction zone being able to charge said sample with capillary forces; and
sample liquid absorption zone position at downstream positions to said reaction zones to absorb liquid contained in said sample;
characterized in that at least one end of said at least two sample carrier zones combine into a connection zone and that at least one end of said at least two reaction zones combine into said or another connection zone.

4. The multiplex test kit as claimed in claim 1, 2 or 3, wherein reagent is provided at selected position or positions of said sample carrier zone.

5. The multiplex test kit as claimed in claim 1, 2 or 3, wherein said sample carrier zone connects with said reaction zone closely, allowing said sample to proceed from said sample carrier zone to said reaction zone.
